(19) United States
(12) Patent Application Publication
(10) Pub. No.: US 2009/0059279 A1
(43) Pub. Date: Mar. 5, 2009

(54) INFORMATION PROCESSING APPARATUS, INFORMATION PROCESSING SYSTEM, AND INFORMATION PROCESSING METHOD

(75) Inventor: Masakatsu Sakurai, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/187,179

(22) Filed: Aug. 6, 2008

(30) Foreign Application Priority Data
Aug. 8, 2007 (JP) 2007-206604

(51) Int. Cl. G06F 3/12

(52) U.S. Cl. 358/1.15

(57) ABSTRACT

An information processing apparatus using a management code including a plurality of layers to designate a charging destination in performing charging based on a result of processing performed by an image processing apparatus includes a determination unit configured to determine whether a conflict exists in print setting items corresponding to respective layers included in the management code, and a setting unit configured to, if it is determined that no conflict exists in the print setting items corresponding to respective layers, set, for the print job, a print setting based on the management code and, if it is determined that a conflict exists in the print setting items corresponding to respective layers, set, for the print job, a print setting based the management code and a policy for determining a print setting for the conflicting print setting items.

### BACKGROUND OF THE INVENTION

1. Field of the Invention

The present invention relates to an information processing apparatus in a charging system, which is configured to designate a charging destination of a print result based on a print job using a management code that includes a plurality of layers.

2. Description of the Related Art

An information processing system is desired which includes a copying machine, a printer, and an information processing apparatus that can communicate with an image processing apparatus during printing, in which system a user can designate on the information processing apparatus a print result calculation destination and a charging destination for each job.

For example, it is necessary for a law firm that handles a number of matters to calculate a printed amount for each matter and to charge the calculated print cost to a client of the matter.

In order to respond to the desire for such an information processing system, a conventional method designates a management code for each print job to perform a print operation. In such a conventional method, a printer driver sets a management code each time a user performs printing. In setting a management code, a conventional method selects a management code previously stored in the printer driver. Alternatively, a user inputs a management code via a keyboard.

A management code can include a plurality of layers. By using a management code including a plurality of layers, an administrator of the system can designate a code for each layer and in this case, one charging destination can be indicated by a plurality of codes.

More specifically, for example, the layers can be defined in a manner such that the first layer includes a code for a customer, the second layer for a work phase (a progress of work), and the third layer for significance of a concerned document.

In most cases of managing charging, a print form and print conditions are previously determined uniquely to a customer (charging destination) and according to the purpose of printing of a document.

However, if a print setting is required to be performed according to a charging destination, then it is necessary for an operator to take the time and trouble of performing a complicated operation for the print setting at the time of printing. Accordingly, if a wrong setting has been set and the operator becomes aware of the mistake in print setting, then the operator is required to perform printing of the document again.

In this regard, Japanese Patent Application Laid-Open No. 2005-310029 discusses a method for reducing the trouble of a user to perform a detailed setting via a setting screen of a printer driver. In the method discussed in Japanese Patent Application Laid-Open No. 2005-310029, the user selects a desired printing category and is only required to display and select a print setting required for the selected printing category.

However, the conventional method discussed in Japanese Patent Application Laid-Open No. 2005-310029 does not describe a method for performing a print setting according to a charging destination. That is, Japanese Patent Application Laid-Open No. 2005-310029 does not discuss a method for setting a print condition according to a management code having a plurality of layers.

At the time of designating a charging destination using a management code, one management code may include a print condition for each of a plurality of layers. Furthermore, print setting items to be designated for respective layers may conflict in one management code.

Under such circumstances, a method is desired for improving a user's convenience in designating a print condition according to a charging destination in a charging system, in which the charging destination is designated with a management code having a plurality of layers.

### SUMMARY OF THE INVENTION

The present invention is directed to an information processing apparatus and an information processing method that can improve a user's convenience in designating a print condition according to a charging destination in a charging system, in which the charging destination is designated with a management code having a plurality of layers.

According to an aspect of the present invention, an information processing apparatus capable of using a management code including a plurality of layers to designate a charging destination in performing charging based on a result of processing performed by an image processing apparatus includes a designation unit configured to designate, for a print job, the management code in which a code has been designated for at least two layers, in response to a user instruction, a determination unit configured to determine whether a conflict exists in print setting items corresponding to respective layers included in the management code designated by the designation unit, and a setting unit configured to, if it is determined by the determination unit that no conflict exists in the print setting items corresponding to respective layers, set, for the print job, a print setting based on the management code designated by the designation unit and, if it is determined by the determination unit that a conflict exists in the print setting items corresponding to respective layers and a print setting is set, for the print job, based on the management code designated by the designation unit, set the print setting in the conflicting print setting items based a policy for determining a print setting for the conflicting print setting items.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an example of an information processing system to which an information processing apparatus according to an exemplary embodiment of the present invention can be applied.

FIG. 2 illustrates an example of a hardware configuration of the information processing apparatus according to an exemplary embodiment of the present invention.

FIG. 3 illustrates an exemplary flow of data processing in the information processing system illustrated in FIG. 1 according to an exemplary embodiment of the present invention.

FIG. 4 illustrates an example of a user interface displayed on a server illustrated in FIG. 1 according to an exemplary embodiment of the present invention.

FIG. 5A illustrates an example of a user interface displayed on the server illustrated in FIG. 1 according to an exemplary embodiment of the present invention.

FIG. 5B illustrates an example of a user interface displayed on the server illustrated in FIG. 1 according to an exemplary embodiment of the present invention.

FIG. 5C illustrates an example of a user interface displayed on the server illustrated in FIG. 1 according to an exemplary embodiment of the present invention.

FIG. 6 illustrates an example of a user interface displayed on the server illustrated in FIG. 1 according to an exemplary embodiment of the present invention.

FIGS. 7A and 7B each illustrate an example of a user interface displayed on a host personal computer (PC) illustrated in FIG. 1 according to an exemplary embodiment of the present invention.

FIG. 8 illustrates an example of a user interface displayed on the host PC illustrated in FIG. 1 according to an exemplary embodiment of the present invention.

FIG. 9 is a flow chart illustrating an example of data processing performed by the server according to an exemplary embodiment of the present invention.

FIG. 10 is a flow chart illustrating another exemplary data processing performed by the server according to an exemplary embodiment of the present invention.

FIG. 11 is a flow chart illustrating yet another exemplary data processing performed by the server according to an exemplary embodiment of the present invention.

FIG. 12 is a flow chart illustrating yet another exemplary data processing performed by the server according to an exemplary embodiment of the present invention.

FIG. 13 is a flow chart illustrating yet another exemplary data processing performed by the server according to an exemplary embodiment of the present invention.

FIG. 14 is a flow chart illustrating an example of data processing performed by the information processing apparatus according to an exemplary embodiment of the present invention.

FIG. 15 is a flow chart illustrating yet another exemplary data processing performed by the information processing apparatus according to an exemplary embodiment of the present invention.

FIG. 16 is a flow chart illustrating yet another exemplary data processing performed by the server apparatus according to an exemplary embodiment of the present invention.

FIG. 17 is a memory map of a storage medium storing various types of data processing programs that can be read by the server according to an exemplary embodiment of the present invention.

FIG. 18 is a memory map of a storage medium storing various types of data processing programs that can be read by the information processing apparatus according to an exemplary embodiment of the present invention.

### DETAILED DESCRIPTION OF THE EMBODIMENTS

Various exemplary embodiments, features, and aspects of the present invention will now be are herein described in detail below with reference to the drawings. It is to be noted that the relative arrangement of the components, the numerical expressions, and numerical values set forth in these embodiments are not intended to limit the scope of the present invention.

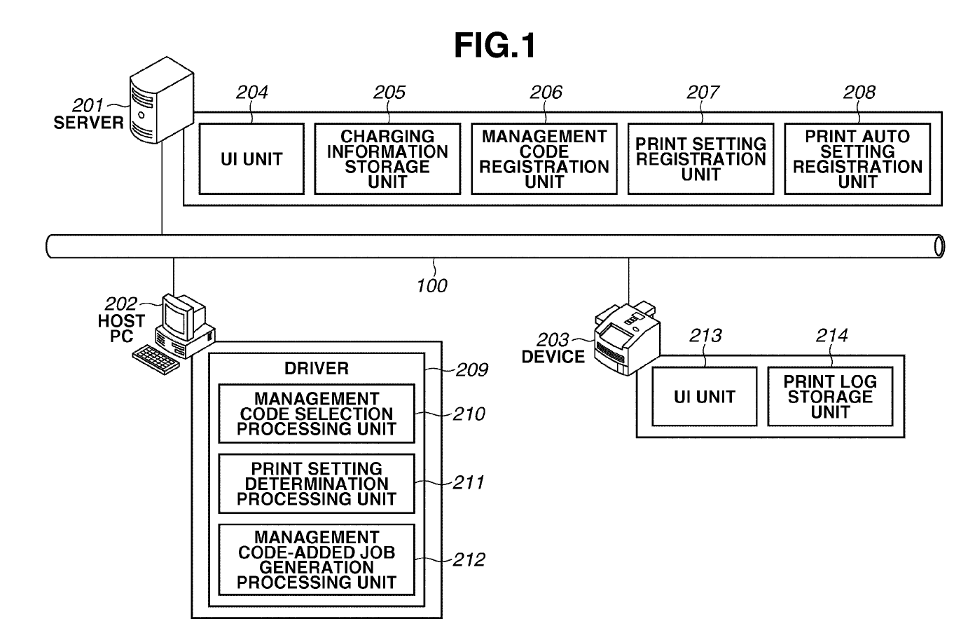

FIG. 1 illustrates an example of an information processing system to which an information processing apparatus according to an exemplary embodiment of the present invention can be applied. The information processing system is configured to designate a charging destination of a result of processing based on a print job using a management code including a plurality of layers designated by a user. In the present exemplary embodiment, the above-described management code includes a plurality of layers. A code can be designated for each layer.

Furthermore, the information processing system according to the present exemplary embodiment includes an information processing apparatus (hereinafter referred to as a “host PC”), an image processing apparatus (hereinafter simply referred to as a “device”), such as a multifunction peripheral (MFP), a copying machine, a printer or the like, and a server. The host PC, the device, and the server according to the present exemplary embodiment are distributed on and in communication with one another via a network. Moreover, various application software for adding up output results, which cooperatively operates on respective platforms, is installed on the host PC, the device, and the server, respectively. The application software is used for performing various data processing operations, which will be described in detail below.

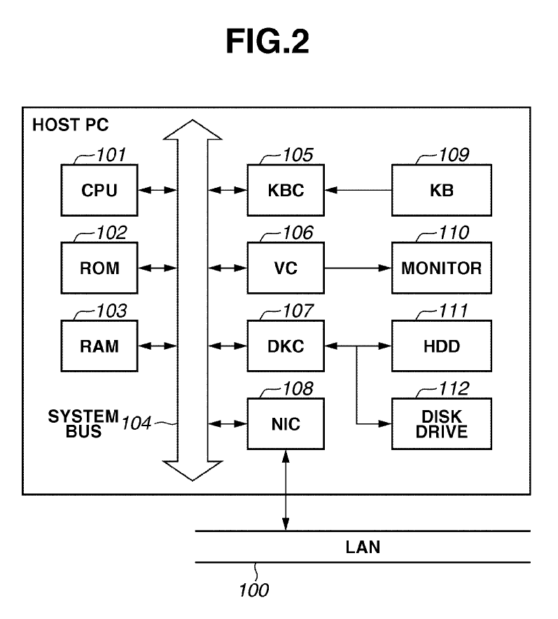

Referring to FIG. 1, a charging management server (hereinafter simply referred to as a “server”) 201 includes a hardware resource illustrated in FIG. 2, which will be described in detail below. Furthermore, the server 201 includes a software resource for performing specific functional processing. Moreover, the server 201 includes a user interface (UI) unit 204 for performing processing for adding up print results and charging processing.

The UI unit 204 displays a screen on a monitor, via which an administrator of the system (hereinafter simply referred to as an “administrator”) can input a management code, a print setting, and a print auto setting to register the same on the server 201.

Furthermore, the server 201 includes a charging information storage unit 205 having a function for storing various information for controlling charging for print processing input by the administrator and print log information acquired from the device.

In addition, the server 201 includes a management code registration unit 206 having a function for registering a management code including a plurality of layers input by the administrator via the UI unit 204. Furthermore, the management code registration unit 206 sets an upper limit value for a number of prints for each management code.

A code can be set for each of the plurality of layers identified as a charging destination. The management code will be described in detail below.

In addition, the server 201 includes a print setting registration unit 207. The print setting registration unit 207 has a function for registering a print setting for a code corresponding to each layer identified with one management code that is input via the UI unit 204, and a function for registering a common policy setting for determining a print setting. The common policy will be described in detail below.

Furthermore, the print setting registration unit 207 registers and stores a print setting value that has been automatically changed and information indicating notifying to the user that the print setting value has been automatically changed.

Furthermore, the server 201 includes a print auto setting registration unit 208. The print auto setting registration unit 208 has a function for registering an item for automatically changing a print setting for each code corresponding to each layer identified with one management code input via the UI unit 204.

A host PC 202 includes a driver 209, which communicates with a device 203 via a network 100 to send a generated job to the device 203. In the present exemplary embodiment, the device 203 includes an MFP. However, the device 203 can be a single-function device, such as a printer. Furthermore, the driver 209 is installed on a hard disk of the host PC 202 and performs print control under the control of an operating system (OS).

In the case where the device 203 is an MFP, the device 203 further includes a plurality of drivers corresponding to the data processing functions other than the print function. The data processing function other than the print function includes a copy function, a scanner function, a facsimile transmission function, and a BOX function for storing data.

Furthermore, in the case where the device 203 is a printer, the driver 209 is a printer driver. The printer driver communicates with the device 203 using a predetermined protocol to issue an output instruction to the device 203.

In the present exemplary embodiment, the driver 209 includes the following functional processing units.

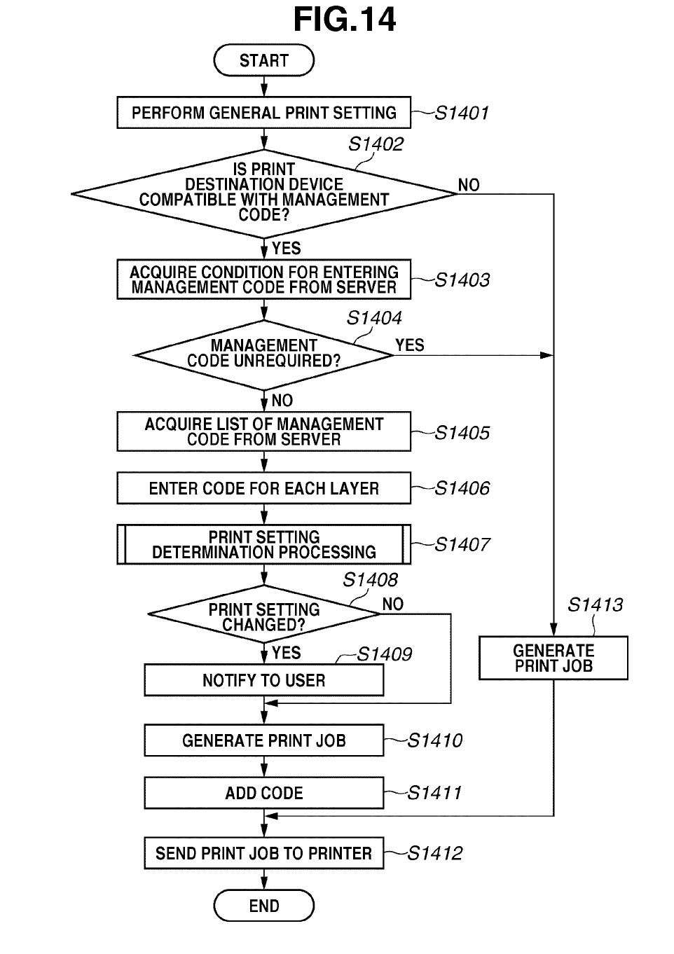

More specifically, the driver 209 includes a management code selection processing unit 210, a print setting determination processing unit 211, and a management code-added job generation processing unit 212. The management code selection processing unit 210 selects a code for each of a plurality of layers. The print setting determination processing unit 211 determines a print setting. The management code-added job generation processing unit 212 adds a management code to a print job. Here, the print setting determination processing unit 211 performs print setting determination processing illustrated in FIG. 14. The print setting determination processing will be described in detail below.

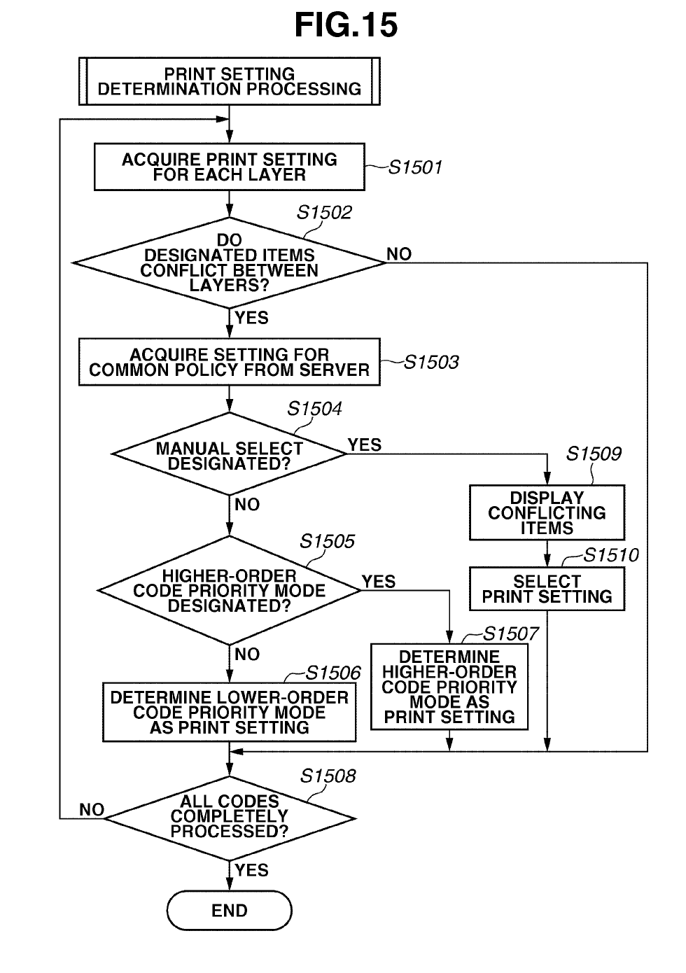

During the print setting determination processing, the print setting determination processing unit 211 acquires print setting information for each layer that the driver 209 acquires from the server 201 and setting information for the common policy for adjusting conflicting setting. Then, the print setting determination processing unit 211 determines a print setting for the generated print job according to the setting information for the common policy that has been set by the administrator. The print setting determination processing will be described in detail below with reference to FIGS. 14 and 15.

The device 203 includes a UI unit 213 and a print log storage unit 214. When a user utilizes the copy function and the facsimile transmission function of the device 203, the UI unit 213 executes a function for displaying various setting screens, verification screens, and error display screens on an operation panel for directly operating the device 203.

Furthermore, the print log storage unit 214 stores output results of the device 203.

FIG. 2 illustrates an example of a hardware configuration of an information processing apparatus according to the present exemplary embodiment. In the example illustrated in FIG. 2, the information processing apparatus is the host PC 202 illustrated in FIG. 1. The server 201 includes similar hardware resources as those illustrated in FIG. 1.

Referring to FIG. 2, a central processing unit (CPU) 101 executes a program stored on the ROM 102 or a hard disk drive (HDD) 111 using the RAM 103 as a work memory. Furthermore, the CPU 101 controls internal devices connected with the CPU 101 via a system bus 104 by executing the above-described program and performs output result add-up processing.

The HDD 111 stores various programs and data including the OS and software for performing the output result add-up processing. The software for performing the output result add-up processing is supplied on a storage medium, such as a compact disc-read only memory (CD-ROM), which can be mounted on a disk drive 112.

The CPU 101 accesses the HDD 111 and the disk drive 112 via a disk controller (DKC) 107 and installs the output result add-up software on the HDD 111.

Furthermore, the CPU 101 displays a user interface (UI) on a monitor 110 via a video card (VC) 106 according to a program stored on the ROM 102. The user operates a keyboard (KB) 109 and a pointing device, such as a mouse, to issue an instruction and enter information via a UI displayed on the monitor 110.

In addition, the CPU 101 accepts an instruction and an input by the user via a keyboard controller (KBC) 105, and executes various processing according to an instruction and input by the user.

Furthermore, the CPU 101 can communicate with another host PC, a server, or a device (such as a printer or a copying machine) on the network 100 by a predetermined protocol via a network interface card (NIC) 108.

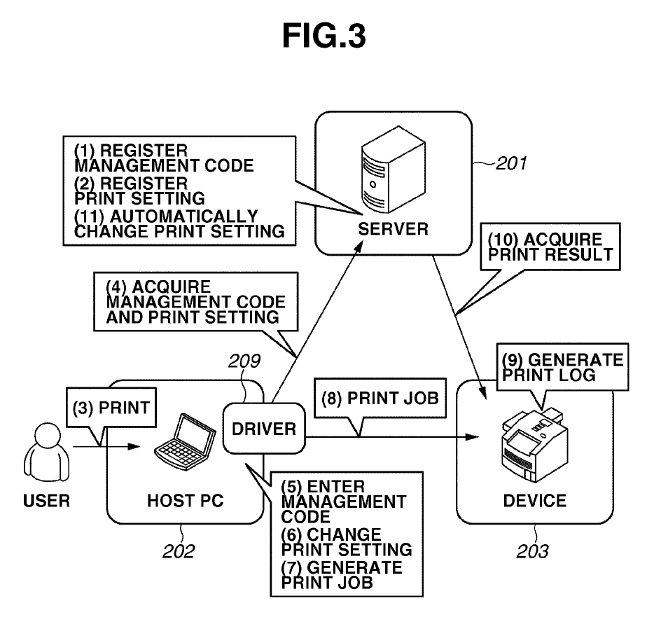

FIG. 3 illustrates an exemplary flow of data processing performed in the information processing system illustrated in FIG. 1 according to the present exemplary embodiment. Similar components of the information processing system to those illustrated in FIG. 1 are provided with the same numerals and symbols. Furthermore, in the example illustrated in FIG. 3, the information processing system performs processing (1) through (11).

Referring to FIG. 3, in the information processing system according to the present exemplary embodiment, the server 201, the host PC 202, and the device 203 can communicate with one another via a network (not illustrated in FIG. 3).

The server 201 performs management code registration processing (1), print setting registration processing (2), and print setting auto change processing (11).

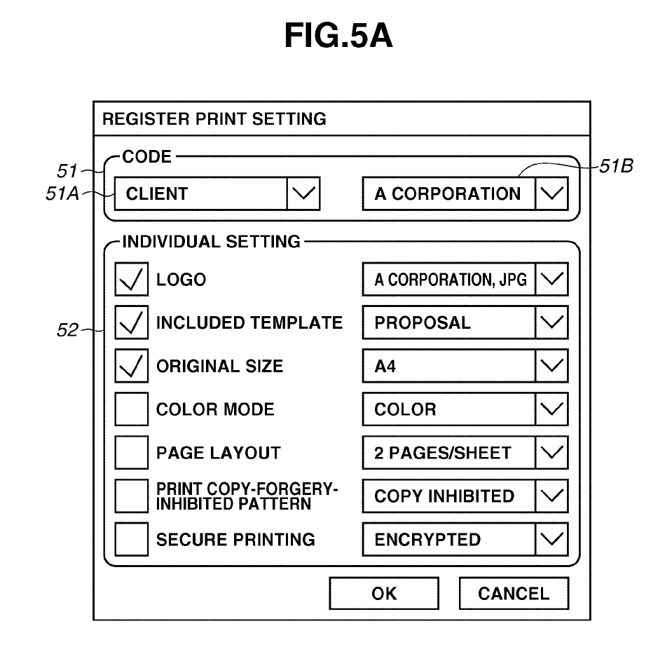

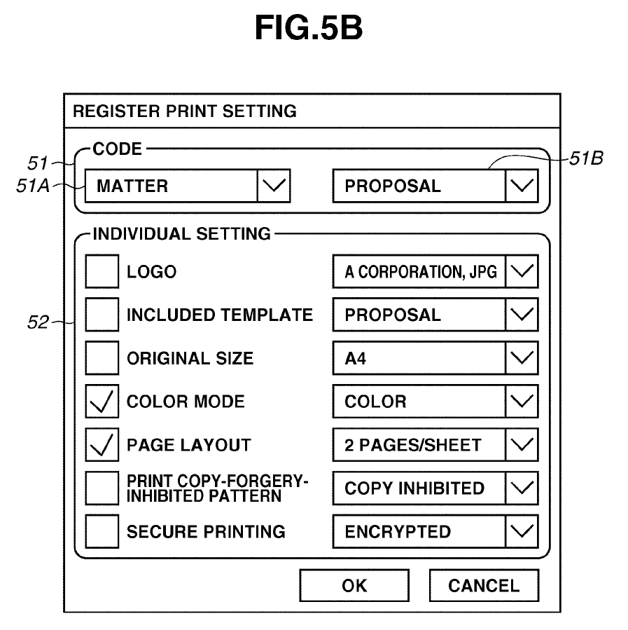

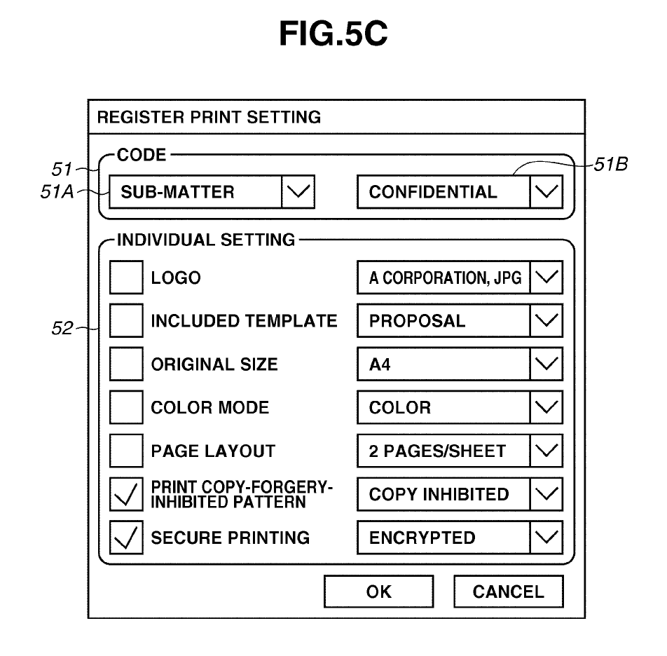

In the present exemplary embodiment, the management code includes a code corresponding to each of a plurality of layers as illustrated in FIGS. 5A through 5C. For example, a management code includes three layers, namely, a client layer, a matter layer, and a sub-matter layer. Furthermore, in the present exemplary embodiment, in the case of setting codes for a plurality of layers, a plurality of codes that can be set for respective layers is previously registered. Here, a user can input a code directly for each layer. In the present exemplary embodiment, processing for registering a code for each layer of the management code is referred to as “first registration processing”.

In the present exemplary embodiment, for example, a customer company name, such as “A corporation”, “B corporation”, or “C corporation”, is registered as a code for the first layer (“client”). Furthermore, a work phase, such as proposal, estimation, reporting, and delivery, is registered as a code for the second layer (“matter”). Furthermore, a document type, such as “confidential”, “important”, “for internal use only”, or “general”, is registered as a code for the third layer (“sub-matter”).

In the present exemplary embodiment, the client, matter, and sub-matter layers are used. However, the present invention is not limited to these. That is, an administrator or a user can arbitrarily define the name for each of the three layers and how each of the layers is used.

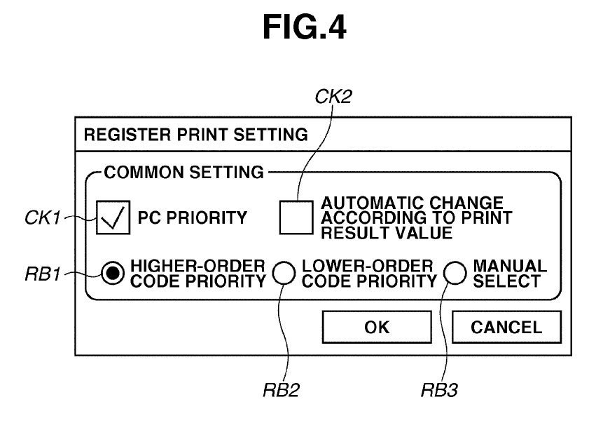

For the print setting registration processing (2), a common setting field is displayed in a print setting registration window for designating a method for correcting a conflict of print setting items corresponding to respective layers, as illustrated in FIG. 4 as a user interface.

In the present exemplary embodiment, an administrator (user) can set either “PC priority” or “automatic change according to print result value” for a common policy for adjusting a conflict of print setting items.

Furthermore, in the case of setting “automatic change according to print result value”, an administrator (user) can select which layer is to be prioritized or whether the change is manually performed.

In the case where the administrator has set a common policy to cancel the conflicting print setting via the user interface illustrated in FIG. 4, the set common policy is registered on the print setting registration unit 207. Here, in the present exemplary embodiment, processing for registering a policy is referred to as “second registration processing”.

The registered common policy is acquired when the host PC 202 acquires a print setting based on the input code for each layer or if it is determined that the acquired print setting items for respective codes based on the management code conflict.

Furthermore, the print setting registration processing (2) includes processing for registering a print setting for each layer as indicated with a previous registration of the print setting with respect to the management code as indicated by the user interface illustrated in FIGS. 5A through 5C.

When the user performs printing (3) on the host PC 202, the driver 209 issues to the server 201 a request for acquiring a management code and a print setting in the processing (4). After receiving the request from the driver 209, the server 201 sends to the host PC 202 a management code and a list of print settings registered on the server 201.

Then, the driver 209 displays a list of codes for a plurality of layers to allow the user to select a code for each layer in the processing (5).

Then, based on the print setting designated in the code selected by the user and the common policy setting, the driver 209 performs a print setting change determination in processing (6). Then, the driver 209 generates a print job using the determined print setting in processing (7).

Furthermore, the driver 209 adds a code having a plurality of layers to the generated print job. Moreover, in processing (8), the driver 209 sends to the device 203 the print job generated according to the changed print setting and added with the management code.

In processing (9), the device 203 performs print processing based on the received print job and generates log data indicating a print result.

Furthermore, in the processing (10), the server 201 collects print log information from the device 203 as print result information either periodically or in response to an event. In addition, in processing (11), the server 201 automatically changes the print setting based on the designated automatic change of the print setting and sends the automatically changed information (print setting) in response to a subsequent request for a print setting.

FIG. 4 illustrates an example of a user interface displayed on the server 201 illustrated in FIG. 1 according to the present exemplary embodiment. The exemplary user interface illustrated in FIG. 4 is displayed on the display device of the server 201 at the time the administrator (user) registers the print setting on the server 201.

Referring to FIG. 4, a check box CK1 can be marked to select the setting “PC priority”.

Here, the setting “PC priority” refers to a setting for designating, in the case of issuing a print instruction from the driver 209 of the host PC 202, that the print setting registered for each management code and set on the server 201 can be changed via the host PC 202.

That is, in the case where the setting “PC priority” has been selected, the print setting on the server 201 is merely a recommendation value. Accordingly, the user can change the print setting to perform printing in this case. On the other hand, in the case where the setting “PC priority” has not been selected, the print setting on the server 201 is a mandatory setting. Accordingly, the print setting on the server 201 is set with a higher priority than the print setting set on the host PC 202.

A check box CK2 can be marked by the administrator (user) to select the setting “automatic change according to print result value”. Here, the setting “automatic change according to print result value” refers to a setting for designating whether to automatically change the print setting based on the print result that the server 201 acquires from the device 203 after printing. Furthermore, the “print result” refers to a result of printing corresponding to the management code itself or a code for each layer.

As described above, in the present exemplary embodiment, the print result is stored on a storage device in the server 201. Thus, when the server 201 determines whether a print setting item exists that exceeds a threshold value determined based on the stored print result, the server 201 changes the print result exceeding the threshold value to a print setting with which printing cost can be appropriately reduced.

In this regard, it is useful to change a color printing setting to a monochromatic printing setting and a one-sided print output setting to a two-sided print output setting. However, the change setting is not limited to those. That is, it is also useful to use a print setting combination with which printing cost can be reduced. Furthermore, in the case of changing a print setting based on a print result using a print setting combination, it is useful that the print setting can be customized according to a user's desire.

When the administrator has selected the setting “automatic change according to print result value”, the administrator can designate a common policy to be determined via the following radio buttons.

Each of radio buttons RB1 through RB3 can be operated by a user to designate a common policy for determining a print setting if it is determined that print setting items for codes for a plurality of layers selected by the user during printing conflict and if different print settings have been registered.

More specifically, the radio button RB1 functions as a button for designating “higher-order code priority” as a common policy. The radio button RB2 functions as a button for designating “lower-order code priority” as a common policy. The radio button RB3 functions as a button for designating “manual select” as a common policy.

If the radio button RB1 has been designated, that is, if the setting “higher-order code priority” has been designated, then the print setting is determined so that the designation in a higher-order code (designation in a code for the first layer) is prioritized and the priority becomes lower for the designation in a lower-order code (designation in a code for the second layer and below). In the present exemplary embodiment, according to the layer names, the designation for the “client” is prioritized highest. The priority for the layers “matter” and “sub-matter” becomes lower in this order.

On the other hand, if the radio button RB2 has been designated, the print setting is determined so that a designation for a lower-order layer (a third layer) is prioritized higher than the higher-order layer (the first layer), and thus the priority becomes lower for the higher-order layer (the first layer and beyond). In the present exemplary embodiment, in this case, the designation for the layer “sub-matter” is most highly prioritized. The priority for the layers “matter” and “client” becomes lower in this order.

On the other hand, if the radio button RB3 has been designated, then a screen is displayed in a pop-up manner indicating a dialog for notifying the user that the print setting items conflict and prompting the user to select one of the conflicting print setting items when the print processing by the host PC 202 starts and after the management code is selected. The print setting is determined according to the item selected by the user. Here, the print setting information for determining a common policy set via the user interface illustrated in FIG. 4 is registered on the print setting registration unit 207. Then, when the server 201 receives the request for acquiring the print setting information, the server 201 sends the print setting to the host PC 202.

FIGS. 5A through 5C each illustrate an example of a user interface displayed on the server 201 illustrated in FIG. 1 according to the present exemplary embodiment. In the examples illustrated in FIGS. 5A through 5C, the content of the registered print setting with respect to each layer is displayed on the server 201. FIG. 5A illustrates a content of the registered print setting with respect to the “client” layer. FIG. 5B illustrates a content of the registered print setting with respect to the “matter” layer. FIG. 5C illustrates a content of the registered print setting with respect to the “sub-matter” layer.

Referring to FIGS. 5A through 5C, the item that can be set in each layer commonly includes a code 51 and a printing setting field 52. The code 51 includes a selection field 51A for selecting a layer and a code selection field 51B for selecting content of the code 51. In the present exemplary embodiment, the management code is designated by setting a code for each layer. Furthermore, in order to designate a management code, it is necessary to set a code for at least one layer. Moreover, the management code includes the following print setting items. In addition, a print setting exists corresponding to a code that corresponds to each layer. Here, a code can be designated according to an arbitrary method as long as the code can be uniquely represented with a numeral, a symbol, and a character string.

In the present exemplary embodiment, the management code has three layers, namely, the client layer, the matter layer, and the sub-matter layer. More specifically, in the present exemplary embodiment, the codes “A corporation”, “proposal”, and “confidential” are set for respective layers.

The print setting field 52 includes a designation of a logo mark to be added during printing, a designation for a template to be used during the printing, a designation for an original size, a designation for color mode, a designation for page layout, a designation for copy-forgery-inhibited pattern printing, and a designation for secure printing. The administrator may set each designation by marking on a corresponding check box.

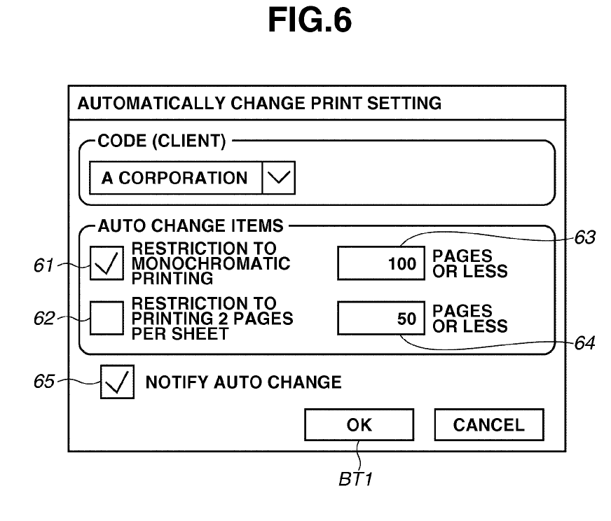

FIG. 6 illustrates an example of a user interface displayed with the server 201 illustrated in FIG. 1 according to the present exemplary embodiment. The example illustrated in FIG. 6 illustrates an exemplary print setting auto change screen for setting a print condition for automatically changing a print setting based on a print result on the server 201.

Furthermore, in the example illustrated in FIG. 6, the administrator designates a restriction to monochromatic printing and a condition therefor with respect to the code in the first layer (“client layer”). In the screen illustrated in FIG. 6, a check box 61 is marked to designate the restriction to monochromatic printing. For a condition 63 for the restriction to monochromatic printing, the number of pages is set to equal to or less than “100” pages. The restriction to monochromatic printing is an automatic change item. When the restriction to monochromatic printing is set, the color printing is inhibited and the printing is restricted to monochromatic printing if the number of remaining printable pages is equal to or less than 100 pages for the designation condition 63.

The administrator (user) can mark a check box 62 to set a setting of a restriction to “printing two pages per sheet”. In the screen illustrated in FIG. 6, for a designation condition 64 for the restriction to “printing two pages per sheet”, “50 pages or less” is set for the number of pages. Here, the restriction to “printing two pages per sheet” is an automatic change item. When the restriction to printing two pages per sheet is set, if the number of the remaining printable pages has become 50 pages or less with respect to the designation condition 64, the present exemplary embodiment restricts the printing so that image data for two pages is printed on one sheet with reduced scale printing.

A check box 65 is used for designating whether to notify the user that the print setting has been automatically changed.

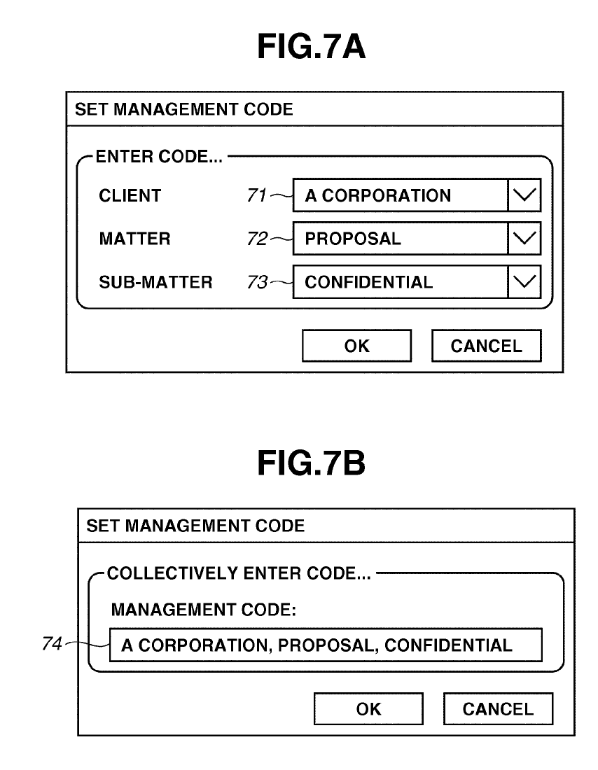

FIGS. 7A and 7B each illustrate an example of a user interface displayed on the host PC 202 (FIG. 1) according to the present exemplary embodiment. More specifically, the example illustrated in each of FIGS. 7A and 7B illustrates an example of a dialog for designating a management code in the case of performing printing with the driver 209 of the host PC 202.

FIG. 7A illustrates an example of a user interface via which the user selects codes for the three layers (each of layers 71 through 73) from a menu according to the present exemplary embodiment. FIG. 7B illustrates an example of a user interface for collectively entering the codes for the three layers in an entry field 74 using a delimiter “,”, for example, according to the present exemplary embodiment.

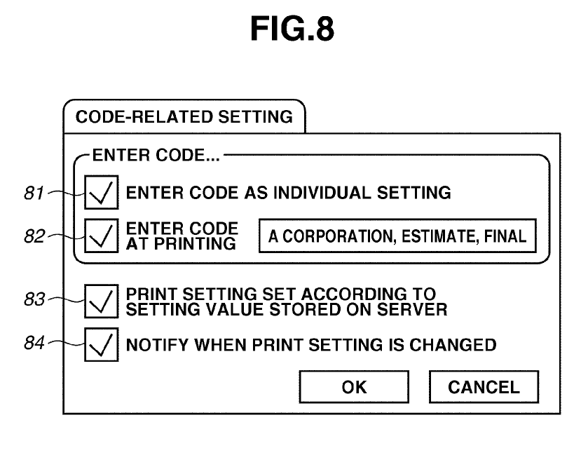

FIG. 8 illustrates an example of a user interface displayed on the host PC 202 illustrated in FIG. 1 according to the present exemplary embodiment. In the example illustrated in FIG. 8, a property sheet used for a basic setting related to entering the management code for the driver 209 on the host PC 202 is displayed.

Referring to FIG. 8, a check box 81 functions as a check box for designating an individual input as a method for entering a code. A check box 82 functions as a check box for designating an “entry at printing” as a method for entering a code. In the case where no code is input at each printing, a code is previously designated.

A checkbox 83 functions as a checkbox for designating a change in a print setting in the case where the check box CK1 (FIG. 4) has been marked. On the other hand, if the check box CK1 (FIG. 4) has not been marked, the check box 83 functions as a check box for designating that the recommendation value stored on the server 201 is used as the print setting.

Furthermore, if the check box CK1 illustrated in FIG. 4 has not been marked, the check box 83 displays a message that prompts the user to designate whether to change the print setting on a pop-up window.

A check box 84 functions as a check box for designating whether to notify the user that the print setting has been changed on a pop-up window.

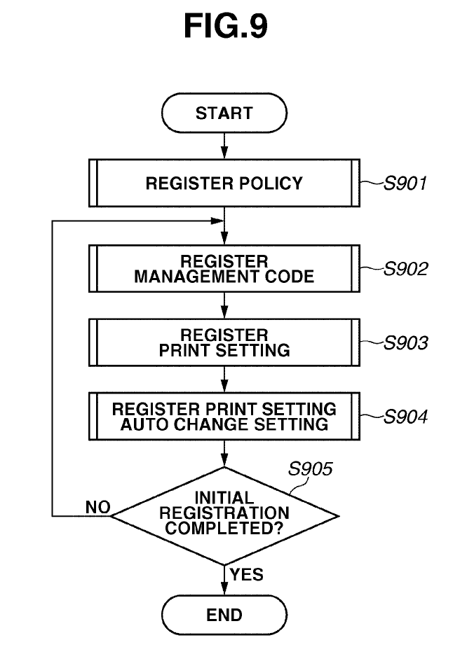

FIG. 9 is a flow chart illustrating an example of data processing performed by the server 201 according to an exemplary embodiment of the present invention. In the example illustrated in FIG. 9, the server 201 performs data processing for initially registering a management code. Each step of the data processing can be implemented with the CPU of the server 201 by loading and executing a control program on a RAM.

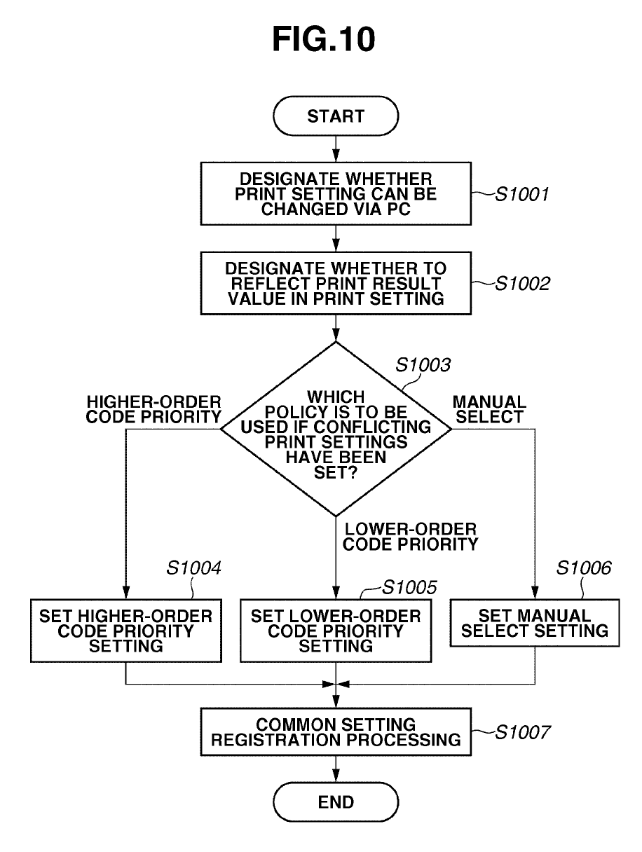

Referring to FIG. 9, in step S901, the CPU of the server 201 displays the user interface illustrated in FIG. 4 and performs processing for registering the setting item related to the common policy. The processing for registering the setting item for the common policy will be described in detail below with reference to the flow chart of FIG. 10.

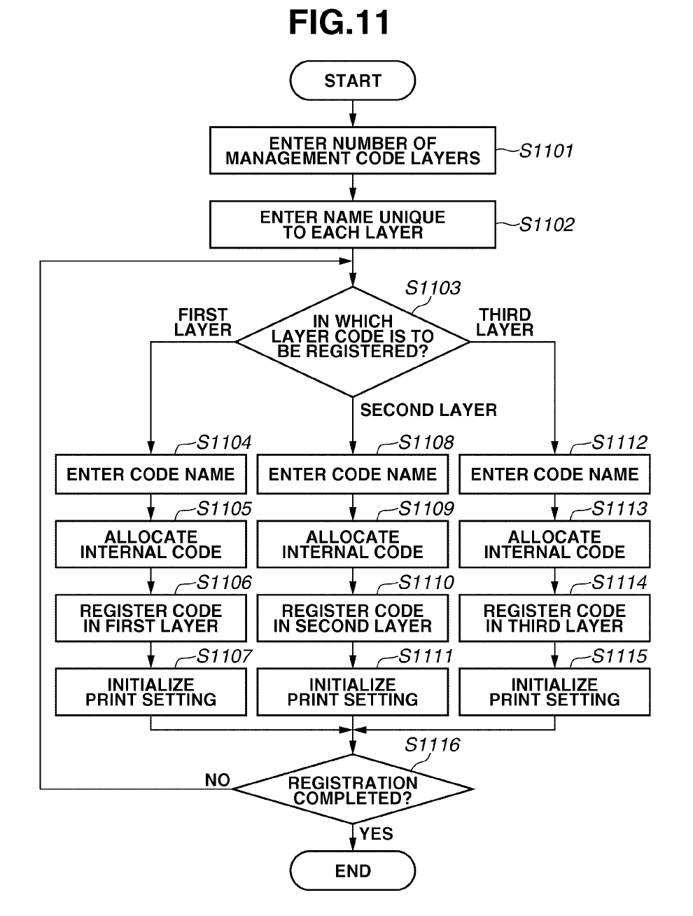

In step S902, the CPU of the server 201 performs the management code registration processing. The processing for registering a management code having a plurality of layers will be described in detail below with reference to the flow chart of FIG. 11.

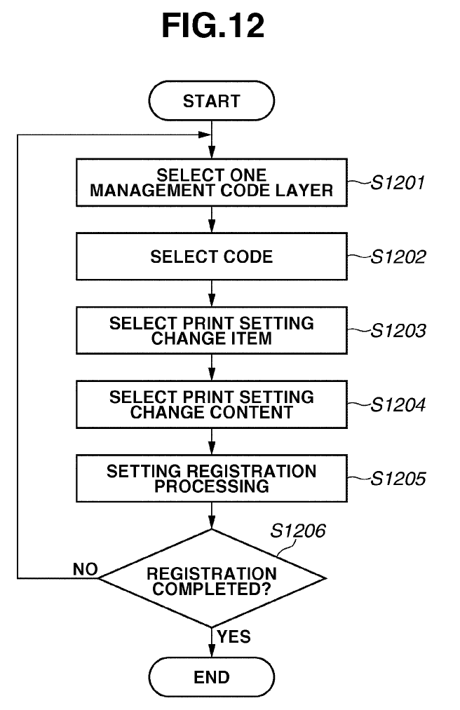

In step S903, the CPU of the server 201 displays the user interface illustrated in FIGS. 5A through 5C and performs processing for registering the print setting separately for each of the layers. The processing for registering the print setting separately for each of the layers will be described in detail below with reference to the flow chart of FIG. 12.

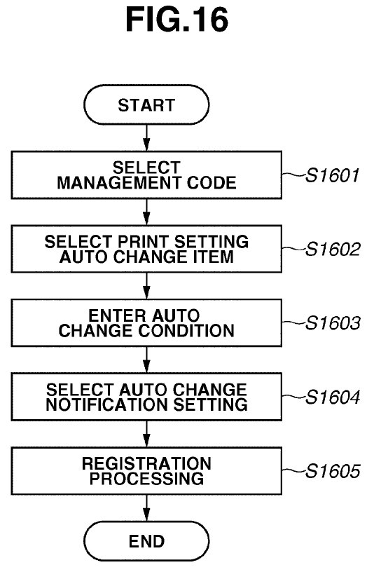

In step S904, the CPU of the server 201 displays the user interface illustrated in FIG. 6 and performs processing for registering the setting related to the automatic change of print setting. The processing for registering the setting related to the automatic change of print setting will be described in detail below with reference to the flow chart of FIG. 16.

In step S905, the CPU of the server 201 determines whether the end of the initial registration for one management code has been instructed. For example, in the case where it is detected that a button BT1 has been pressed via the user interface illustrated in FIG. 6, then it is determined that the end of the initial registration for one management code has been instructed.

If it is determined in step S905 that the end of the initial registration for one management code has not been instructed (NO in step S905), then the processing returns to step S902 to continue the initial registration processing.

On the other hand, if it is determined by the CPU of the server 201 in step S905 that the end of the initial registration for one management code has been instructed (YES in step S905), then the processing ends.

FIG. 10 is a flow chart illustrating an example of data processing performed by the server 201 according to an exemplary embodiment of the present invention. In the example illustrated in FIG. 10, the server 201 performs processing for registering the setting item for the common policy. Each step of the data processing can be implemented with the CPU of the server 201 by loading and executing a control program on a RAM.

Referring to FIG. 10, in a state where the user interface illustrated in FIG. 4 is displayed, in step S1001, the CPU of the server 201 designates whether to “enable” or “disable” the print setting change on the host PC 202. If it is enabled to change the print setting on the host PC 202, then the administrator marks the check box CK1 (FIG. 4).

In the state where the user interface illustrated in FIG. 4 is displayed, in step S1002, the CPU of the server 201 designates whether to reflect the print result value in the print setting. If it is designated to reflect the print result value in the print setting, then the administrator marks the check box CK2 (FIG. 4).

In the state where the user interface illustrated in FIG. 4 is displayed, in step S1003, the CPU of the server 201 determines with which policy the conflict of print settings for codes for a plurality of layers is dissolved.

More specifically, the CPU of the server 201 determines the type set in the common policy used in the case where the print settings conflict based on which of the radio buttons RB1 through RB3 on the user interface (FIG. 4) has been pressed.

If it is determined by the CPU of the server 201 in step S1003 that the radio button RB1 on the user interface (FIG. 4) has been pressed, then the processing advances to step S1004. That is, if it is determined by the CPU of the server 201 in step S1003 that the higher-order code priority setting has been set, then the processing advances to step S1004. In step S1004, the CPU of the server 201 performs the print setting for prioritizing the higher-order code. Then, the processing advances to step S1007.

On the other hand, if it is determined by the CPU of the server 201 in step S1003 that the radio button RB2 on the user interface (FIG. 4) has been pressed, then the processing advances to step S1005. That is, if it is determined by the CPU of the server 201 in step S1003 that the lower-order code priority setting has been set, then the processing advances to step S1005. In step S1005, the CPU of the server 201 performs the print setting for prioritizing the lower-order code. Then, the processing advances to step S1007.

Furthermore, if it is determined by the CPU of the server 201 in step S1003 that the radio button RB3 on the user interface (FIG. 4) has been pressed, then the processing advances to step S1006. That is, if it is determined by the CPU of the server 201 in step S1003 that the manual select setting has been set, then the processing advances to step S1006. In step S1006, the CPU of the server 201 performs the manual select setting. Then, the processing advances to step S1007.

In step S1007, the CPU of the server 201 performs processing for registering the common settings set in steps S1001 through S1006 on the print setting registration unit 207 (FIG. 1). Then, the processing ends.

FIG. 11 is a flow chart illustrating an example of data processing performed by the server 201 according to an exemplary embodiment of the present invention. In the example illustrated in FIG. 11, the server 201 performs the management code registration processing. Each step of the data processing can be implemented with the CPU of the server 201 by loading and executing a control program on a RAM.

Referring to FIG. 11, in step S1101, the administrator operates the keyboard to enter the number of layers included in one management code used in the information processing system. In the present exemplary embodiment, the number of layers is set at “3”. However, a necessary number of layers can be used according to the environment of use of the information processing system. If the value “3” has been input for the number of layers, then three codes are designated for one management code.

In step S1102, the administrator operates the keyboard to enter a name of each layer according to the input number of layers. In the present exemplary embodiment, the entered number of layers is “3”, as described above. Accordingly, the administrator enters a name for each of the first through third layers. More specifically, the administrator enters “client” for the name of the first layer, “matter” for the second layer, and “sub-matter” for the third layer.

In step S1103, the CPU of the server 201 determines which of the first through third layers has been designated as the registration target layer. If it is determined by the CPU of the server 201 in step S1103 that the registration target layer is the first layer, then the processing advances to step S1104.

In step S1104, the administrator operates the keyboard to enter a code name. In step S1105, the CPU of the server 201 allocates an internal code corresponding to the code name. Here, the internal code to be allocated is sequentially and uniquely determined every time a new management code is registered.

In step S1106, the CPU of the server 201 registers the code name and the internal code for the first layer on the storage device of the server 201.

In step S1107, the CPU of the server 201 initializes each print setting for the registered code, and then the processing advances to step S1116. Note that the settings that the CPU of the server 201 sets in steps S1104 through 1106 are stored on the storage device of the server 201. More specifically, these settings are registered on the print setting registration unit 207 illustrated in FIG. 1, for example.

In step S1116, the CPU of the server 201 determines whether a user instruction for ending the processing for registering each code for one management code has been issued. If it is determined by the CPU of the server 201 in step S1116 that a user instruction for ending the processing for registering each code for one management code has been issued (YES in step S1116), then the processing ends. On the other hand, if it is determined by the CPU of the server 201 in step S1116 that no user instruction for ending the processing for registering each code for one management code has been issued (NO in step S1116), then the processing returns to step S1103. In step S1103, the CPU of the server 201 repeats the processing.

If it is determined by the CPU of the server 201 in step S1103 that the registration target layer is the second layer, then the processing advances to step S1108.

In step S1108, the administrator operates the keyboard to enter a code name. In step S1109, the CPU of the server 201 allocates an internal code corresponding to the code name. Here, the internal code to be allocated is sequentially and uniquely determined every time a new management code is registered.

In step S1110, the CPU of the server 201 registers the code name and the internal code for the second layer on the storage device of the server 201.

In step S1111, the CPU of the server 201 initializes each print setting for the registered code. Then, the processing advances to step S1116. Note that the settings that the CPU of the server 201 sets in steps S1108 through S1111 are stored on the storage device of the server 201. More specifically, these settings are registered on the print setting registration unit 207 illustrated in FIG. 1, for example.

In step S1116, the CPU of the server 201 determines whether a user instruction for ending the processing for registering each code for one management code has been issued. If it is determined by the CPU of the server 201 in step S1116 that a user instruction for ending the processing for registering each code for one management code has been issued (YES in step S1116), then the processing ends. On the other hand, if it is determined by the CPU of the server 201 in step S1116 that no user instruction for ending the processing for registering each code for one management code has been issued (NO in step S1116), then the processing returns to step S1103. In step S1103, the CPU of the server 201 repeats the processing.

If it is determined by the CPU of the server 201 in step S1103 that the registration target layer is the third layer, then the processing advances to step S1112.

In step S1112, the administrator operates the keyboard to enter a code name. In step S1113, the CPU of the server 201 allocates an internal code corresponding to the code name. Here, the internal code to be allocated is sequentially and uniquely determined every time a new management code is registered.

In step S1114, the CPU of the server 201 registers the code name and the internal code for the third layer on the storage device of the server 201.

In step S1115, the CPU of the server 201 initializes each print setting for the registered code. Then, the processing advances to step S1116. Note that the settings that the CPU of the server 201 sets in steps S1112 through S1115 are stored on the storage device of the server 201. More specifically, these settings are registered on the print setting registration unit 207 illustrated in FIG. 1, for example.

In step S1116, the CPU of the server 201 determines whether a user instruction for ending the processing for registering each code for one management code has been issued. If it is determined by the CPU of the server 201 in step S1116 that a user instruction for ending the processing for registering each code for one management code has been issued (YES in step S1116), then the processing ends. On the other hand, if it is determined by the CPU of the server 201 in step S1116 that no user instruction for ending the processing for registering each code for one management code has been issued (NO in step S1116), then the processing returns to step S1103. In step S1103, the CPU of the server 201 repeats the processing.

FIG. 12 is a flow chart illustrating an example of data processing performed by the server 201 according to an exemplary embodiment of the present invention. In the example illustrated in FIG. 12, the server 201 performs processing for registering the print setting for the management code. Each step of the data processing can be implemented with the CPU of the server 201 by loading and executing a control program on a RAM.

Referring to FIG. 12, in step S1201, the administrator operates the keyboard to select either one of layers of one management code to which the print setting is to be set. After either of the layers is selected, the CPU of the server 201 displays either of the user interfaces illustrated in FIGS. 5A through 5C on the display device of the server 201 according to which layer has been selected.

In the present exemplary embodiment, the user interface illustrated in FIG. 5A is displayed on the display device of the server 201 if the “client” (the first layer) is selected. The user interface illustrated in FIG. 5B is displayed on the display device of the server 201 if the “matter” (the second layer) is selected. The user interface illustrated in FIG. 5C is displayed on the display device of the server 201 if the “sub-matter” (the third layer) is selected.

In step S1202, the administrator selects a code from the code selection unit 51B of the code 51 via any one of the user interfaces illustrated in FIGS. 5A through 5C.

In the present exemplary embodiment, the user interface illustrated in FIG. 5A indicates a state in which the administrator has selected “A corporation” as a code from the code selection unit 51B for the “client”, which is the first layer.

Similarly, the user interface illustrated in FIG. 5B indicates the state in which the administrator has selected “proposal” as a code from the code selection unit 51B for the “matter”, which is the second layer.

In addition, similarly, the user interface illustrated in FIG. 5C indicates the state in which the administrator has selected “confidential” as a code from the code selection unit 51B for the “sub-matter”, which is the second layer.

In step S1203, the administrator selects an item whose print setting is to be changed by marking a corresponding setting item of the print setting field 52 via any one of the user interfaces illustrated in FIGS. 5A through 5C.

Furthermore, in step S1204, the administrator selects content of the print setting change with respect to the item that has been designated by marking a corresponding setting item of the printing setting field 52 via any one of the user interfaces illustrated in FIGS. 5A through 5C.

In the present exemplary embodiment, via the user interface illustrated in FIG. 5A, the administrator selects the print setting for printing a “logo” using an “A corporation.JPG” file in the printing setting field 52 with respect to “the client” layer, which is the first layer. Furthermore, via the print setting field 52, the administrator selects the print setting “included template” using a “proposal” template.

Similarly, via the user interface illustrated in FIG. 5B, the administrator selects the print setting with which the “proposal”, which corresponds to the “matter” layer (the second layer), is printed with the setting “color” set for the “color mode”. Furthermore, via the print setting field 52, the administrator selects the print setting that uses the setting “2 pages/sheet” for the setting item “page layout”.

Similarly, via the user interface illustrated in FIG. 5C, the administrator selects the print setting for printing using a background character string “copy inhibited” for the setting “print copy-forgery-inhibited pattern” with respect to the setting “confidential” in the “sub-matter” layer (the third layer). Furthermore, the administrator selects the print setting for printing print data by an encrypted communication with the setting “encrypted” for the setting item “secure printing”.

Note that in the present exemplary embodiment, the print setting is separately designated for the code for each layer. However, the print setting that can be designated for a specific layer can be previously determined.

After having performed the print setting via any one of the user interfaces illustrated in FIGS. 5A through 5C and if it is detected that the administrator has pressed the “OK” button, then the CPU of the server 201 determines that the print setting change item and the content of the change print setting have been finally determined. In step S1205, the CPU of the server 201 registers, on the print setting registration unit 207 in the storage device of the server 201 (FIG. 1), the print setting information according to the content selected in steps S1201 through S1204.

In step S1206, the CPU of the server 201 determines whether the administrator has instructed the end of the registration processing. For example, in the case where an instruction for closing the display of any one of the user interfaces illustrated in FIGS. 5A through 5C has been issued, the CPU of the server 201 determines that the administrator has instructed the end of the registration processing.

If it is determined by the CPU of the server 201 in step S1206 that the user instruction for ending the registration processing has been issued (YES in step S1206), then the processing ends. On the other hand, if it is determined by the CPU of the server 201 in step S1206 that the user instruction for ending the code registration processing has not been issued (NO in step S1206), then, the processing returns to step S1201. In step S1201, the CPU of the server 201 repeats the above-described processing.

Thus, the print setting set individually for each layer is registered on the print setting registration unit 207 in the storage device of the server 201.

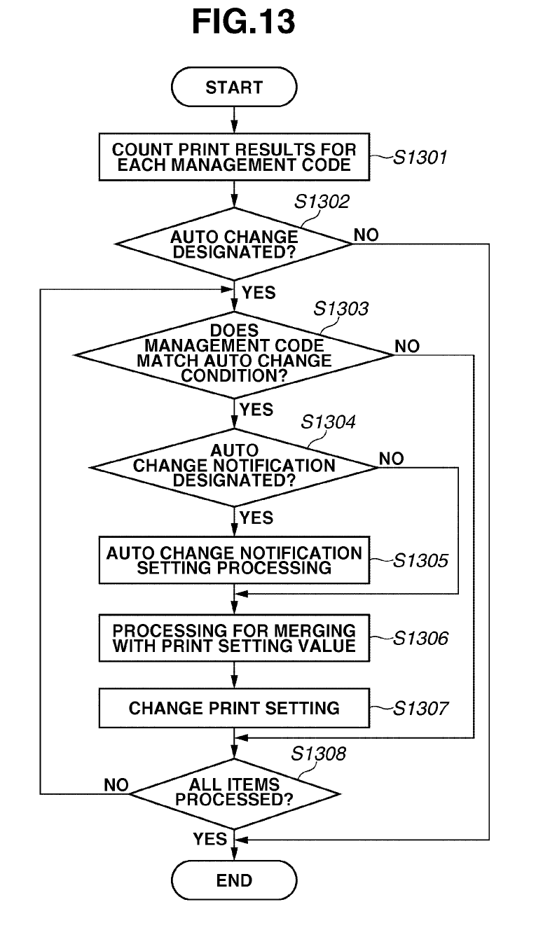

FIG. 13 is a flow chart illustrating an example of data processing performed by the server 201 according to an exemplary embodiment of the present invention. In the example illustrated in FIG. 13, processing is described for automatically changing a print setting based on a result of modification of the print result, which is performed by the server 201. Each step of the data processing can be implemented with the CPU of the server 201 by loading and executing a control program on a RAM.

Furthermore, the server 201 acquires a print log from a device to be managed (including the device 203 illustrated in FIG. 1) by periodically performing polling to the device or based on an event of requesting a log from the device. Then, the server 201 stores the print log acquired from the device as a print result value in the charging information storage unit 205 in the storage device of the server 201 (FIG. 1).

Referring to FIG. 13, in step S1301, the CPU of the server 201 counts the collected result values for each management code registered on the print setting registration unit 207.

Note that the device (including the device 203 illustrated in FIG. 1) includes a nonvolatile storage device for storing print logs. A non-volatile random access memory (NVRAM), a hard disk, or a flash ROM, for example, can be used as the nonvolatile storage device.

In step S1302, the CPU of the server 201 determines whether the check box CK2 for designating an automatic change according to a print result value has been marked in the common setting via the user interface (FIG. 4), according to the content of the print setting stored on the print setting registration unit 207.

If it is determined by the CPU of the server 201 in step S1302 that the check box CK2 for designating an automatic change according to a print result value has not been marked (NO in step S1302), then the processing ends. On the other hand, if it is determined by the CPU of the server 201 in step S1302 that the check box CK2 for designating an automatic change according to a print result value has been marked (YES in step S1302), then the processing advances to step S1303.

In step S1303, the CPU of the server 201 compares each management code registered to be automatically changed via the user interface (FIG. 6) with the condition designated for the automatic change to determine whether the management code registered to be automatically changed matches the condition designated for the automatic change.

If it is determined by the CPU of the server 201 in step S1303 that the management code registered to be automatically changed does not match the condition designated for the automatic change (NO in step S1303), then the processing advances to step S1308. On the other hand, if it is determined by the CPU of the server 201 in step S1303 that the management code registered to be automatically changed matches the condition designated for the automatic change (YES in step S1303), then the processing advances to step S1304.

In step S1304, the CPU of the server 201 determines whether the “notify auto change” check box 65 has been marked by the administrator via the user interface (FIG. 6).

If it is determined by the CPU of the server 201 in step S1304 that the “notify auto change” check box 65 has not been marked (NO in step S1304), then the processing advances to step S1306.

On the other hand, if it is determined by the CPU of the server 201 in step S1304 that the “notify auto change” check box 65 has been marked (YES in step S1304), then the processing advances to step S1305.

In step S1305, the CPU of the server 201 performs setting processing for notifying that the automatic change has been performed on the print setting registration unit 207 in the storage device of the server 201 (FIG. 1).

In step S1306, the CPU of the server 201 performs processing for merging the value designated by the automatic change with the print setting value that has been designated for each code via any one of the user interfaces illustrated in FIGS. 5A through 5C. In the present exemplary embodiment, the merging processing gives a higher priority to an automatically changed print setting value over the print setting set by the policy, so that strict print conditions can be used. For example, in the example illustrated in FIG. 6, page 50 and subsequent pages are printed in the monochromatic printing mode even in the case of the color printing mode. More specifically, in the example illustrated in FIG. 6, the present exemplary embodiment performs processing for changing the content of the print setting to reduce the amount of consumables of the print job.

In step S1307, the CPU of the server 201 updates the print setting, which has been registered for each code on the print setting registration unit 207 (FIG. 1), according to the print setting acquired by the merging processing.

In step S1308, the CPU of the server 201 determines whether all of the print setting items to be automatically changed have been processed.

If it is determined by the CPU of the server 201 in step S1308 that all of the print setting items to be automatically changed have been processed (YES in step S1308), then the processing ends. On the other hand, if not all of the print setting items to be automatically changed have been processed yet (NO in step S1308), then the processing returns to step S1303 to repeat the above-described processing.

FIG. 14 is a flow chart illustrating an example of data processing performed by the host PC 202 according to an exemplary embodiment of the present invention. In the example illustrated in FIG. 14, the host PC 202 performs print processing. Each step of the data processing can be implemented with the CPU 101 of the host PC 202 by loading and executing a control program on the RAM 103.

The driver 209 is included in the above-described control program. When any application software installed on the HDD 111 is activated, the driver 209 in the host PC 202 receives an instruction for starting printing.

Referring to FIG. 14, in step S1401, the user performs various print settings on the driver 209. The print setting performed here is a general print setting.

In step S1402, the driver 209 determines whether the device (including the device 203) that performs the instructed printing is compatible with management code. If it is determined by the driver 209 in step S1402 that the device that performs the instructed printing is not compatible with management code (NO in step S1402), then the processing advances to step S1413. In step S1413, the driver 209 in the host PC 202 generates a print job without the management code. Then, the processing advances to step S1412.

On the other hand, if it is determined by the driver 209 in step S1402 that the device that performs the instructed printing is compatible with management code (YES in step S1402), then the driver 209 advances to step S1403. In step S1403, the driver 209 acquires a condition for entering a management code from the server 201. Here, the entering condition corresponds to the condition for determining whether it is required to enter a management code at the time of printing. The entering condition is previously set in the charging information storage unit 205 in the storage device of the server 201.

In step S1404, the driver 209 in the host PC 202 determines whether management code is unnecessary for performing the print job requested for printing. If it is determined by the driver 209 in the host PC 202 in step S1404 that management code is unnecessary for performing the print job requested for printing (YES in step S1404), then the processing advances to step S1413.

On the other hand, if it is determined by the driver 209 in the host PC 202 in step S1404 that management code is necessary for performing the print job requested for printing (NO in step S1404), then the processing advances to step S1405. In step S1405, the driver 209 acquires a list of management code from the management code registration unit 206 in the storage device of the server 201.

In step S1406, the driver 209 in the host PC 202 allows the user to enter code for each layer via the user interface illustrated in FIG. 7A or FIG. 7B.

In step S1407, the driver 209 in the host PC 202 performs processing for determining print setting, which is described in detail below with reference to FIG. 15.

In step S1408, the driver 209 in the host PC 202 determines whether the print setting has been changed as a result of the processing in step S1407. If it is determined by the driver 209 in the host PC 202 in step S1408 that the print setting has not been changed (NO in step S1408), then the processing advances to step S1410. On the other hand, if it is determined by the driver 209 in the host PC 202 in step S1408 that the print setting has been changed (YES in step S1408), then the processing advances to step S1409.

In step S1409, the driver 209 in the host PC 202 notifies the user that the print setting has been changed via a user interface (not illustrated).

More specifically, the driver 209 in the host PC 202 notifies the user of the change in the case where a designation for notifying the user of the change in the print setting has been performed via the user interface illustrated in FIG. 8 or in the case where information indicating the change is set on the print setting registration unit 207.

In step S1410, the driver 209 in the host PC 202 generates a print job according to the determined print setting. In step S1411, the driver 209 in the host PC 202 adds a code for each layer to the generated print job.

In step S1412, the driver 209 in the host PC 202 sends the generated print job to the device 203. Then, the processing ends.

According to the above-described processing, even if print settings in codes for respective layers acquired from the server 201 conflict in the case of printing a print job with one management code, a print setting can be determined according to the common policy acquired from the server 201.

FIG. 15 is a flow chart illustrating an example of data processing performed by the host PC 202 according to an exemplary embodiment of the present invention. In the example illustrated in FIG. 15, the host PC 202 performs the print setting determination processing. The processing in FIG. 15 illustrates the detail of the processing in step S1407 in FIG. 14. Each step of the data processing can be implemented with the CPU 101 of the host PC 202 by loading and executing a control program on the RAM 103.

Referring to FIG. 15, in step S1501, the driver 209 in the host PC 202 acquires a print setting for each layer from the print setting registration unit 207 of the server 201.

In step S1502, the driver 209 in the host PC 202 determines whether designated items conflict between the layers. That is, the driver 209 in the host PC 202 determines whether the print setting items set in the management code for respective layers acquired from the server 201 conflict.

If it is determined by the driver 209 in the host PC 202 in step S1502 that the designated items do not conflict between the layers (NO in step S1502), then the processing advances to step S1508. On the other hand, if it is determined by the driver 209 in the host PC 202 in step S1502 that the designated items conflict between the layers (YES in step S1502), then the processing advances to step S1503.

In step S1503, the driver 209 in the host PC 202 acquires a setting concerning the common policy, which is registered on the print setting registration unit 207 of the server 201, to determine the print setting.

In step S1504, the driver 209 in the host PC 202 determines whether the common policy designated by the administrator via the user interface illustrated in FIG. 4 is “manual select”.

If it is determined by the driver 209 in the host PC 202 in step S1504 that the common policy designated by the administrator via the user interface illustrated in FIG. 4 is “manual select” (YES in step S1504), then the processing advances to step S1509. On the other hand, if it is determined by the driver 209 in the host PC 202 in step S1504 that the common policy designated by the administrator via the user interface illustrated in FIG. 4 is not “manual select” (NO in step S1504), then the processing advances to step S1505.

In step S1505, the driver 209 in the host PC 202 determines whether the common policy selected by the administrator via the user interface illustrated in FIG. 4 is “higher-order code priority”. If it is determined by the driver 209 in the host PC 202 in step S1505 that the common policy selected by the administrator via the user interface illustrated in FIG. 4 is “higher-order code priority” (YES in step S1505), then the processing advances to step S1507. On the other hand, if it is determined by the driver 209 in the host PC 202 in step S1505 that the common policy selected by the administrator via the user interface illustrated in FIG. 4 is not “higher-order code priority” (NO in step S1505), then the processing advances to step S1506.

In step S1506, the driver 209 in the host PC 202 determines print setting with the content of the print setting based on the lower-order code with respect to the conflicting print setting items. If items conflict in this case, the print setting is determined in the priority order of “sub-matter” (the third layer), “matter” (the second layer), and “client” (the first layer).

In step S1508, the driver 209 in the host PC 202 determines whether the print setting has been determined for all of the codes. If it is determined by the driver 209 in the host PC 202 in step S1508 that the print setting has not been determined for all of the codes (NO in step S1508), then the processing returns to step S1501. On the other hand, if it is determined by the driver in the host PC 202 in step S1508 that the print setting has been determined for all of the codes (YES in step S1508), then the processing ends.

If it is determined by the driver 209 in the host PC 202 in step S1505 that the common policy selected by the administrator via the user interface illustrated in FIG. 4 is “higher-order code priority” (YES in step S1505), then the processing advances to step S1507. In step S1507, the driver 209 in the host PC 202 determines the content of the print setting with the content of the higher-order code and then advances to step S1508. In this case, if items conflict, the print setting is determined in the priority order of “client” (the first layer), “matter” (the second layer), and “sub-matter” (the third layer).

If it is determined by the driver 209 in the host PC 202 in step S1504 that the common policy designated by the administrator via the user interface illustrated in FIG. 4 is “manual select” (YES in step S1504), then the processing advances to step S1509. In step S1509, the driver 209 in the host PC 202 displays conflicting items.

In step S1510, the user selects a print setting via a user interface (not illustrated) provided by the driver 209 in the host PC 202. Then, the processing advances to step S1508.

According to the above-described processing, a conflict of print settings occurring between layers can be automatically dissolved. Thus, it is not necessary for the user to perform a complicated print setting. Accordingly, the present exemplary embodiment can reduce operation load on the user.

Furthermore, in the case where printing is performed by selecting a code set for each layer corresponding to a plurality of printing purposes, the present exemplary embodiment can reduce a possible increase in operation cost due to a failure in printing, by preventing an error in the print setting for each layer.

FIG. 16 is a flow chart illustrating an example of data processing performed by the server 201 according to an exemplary embodiment of the present invention. In the example illustrated in FIG. 16, the server 201 registers the setting for automatically changing print setting based on a print result stored on the charging information storage unit 205. Each step of the data processing can be implemented with the CPU of the server 201 by loading and executing a control program on a RAM. Here, the driver 209 is included in the above-described control program.

Referring to FIG. 16, in step S1601, the administrator selects a code to be set to be automatically changed via the user interface illustrated in FIG. 6. In step S1602, the administrator selects an item whose print setting is to be automatically changed via the user interface illustrated in FIG. 6. The present exemplary embodiment includes the restriction to monochromatic printing and the restriction to printing two pages per sheet.

In step S1603, the administrator enters a change condition for automatically changing the print setting via the user interface illustrated in FIG. 6. In the present exemplary embodiment, the number of remaining pages for each code, which is calculated based on the print result acquired from the device 203, is used as the change condition (the designated conditions 63 and 64 (FIG. 6)). In step S1604, the administrator selects whether to notify the user that the print setting has been automatically changed via the check box 65 in the user interface illustrated in FIG. 6.

In step S1605, the CPU of the server 201 registers the content of the automatic change item set via the user interface on the print auto setting registration unit 208. Then, the processing ends.

According to the above-described processing, in the case where the user processes the print job on the device, the present exemplary embodiment can acquire a print log stored on the device and reflect the content of the change in the print setting on the current print setting based on the print result previously registered on the print setting registration unit 207.

In each of the above-described exemplary embodiments, a part of the processing performed by the server 201 can be processed by the host PC 202.

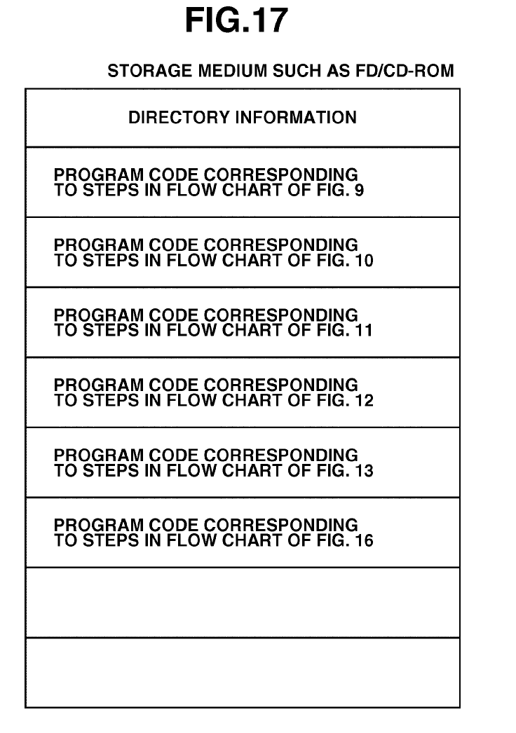

FIG. 17 is a memory map of a storage medium storing various types of data processing programs that can be read by the server 201 according to an exemplary embodiment of the present invention.

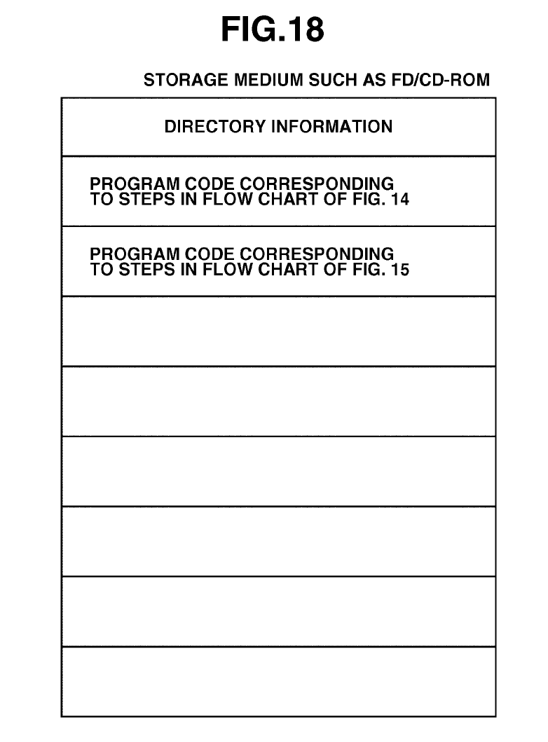

FIG. 18 is a memory map of a storage medium storing various types of data processing programs that can be read by the host PC 202 according to an exemplary embodiment of the present invention.

Although not illustrated in FIG. 17 and FIG. 18, information for managing programs stored in the storage medium, such as version information and information concerning the creator of a program, for example, can be stored in the storage medium. In addition, information that depends on an operating system (OS) of an apparatus that reads a program, such as an icon for identifying and displaying the program, can be stored in the storage medium.

In addition, data that is subordinate to the various programs is also managed in a directory of the storage medium. In addition, a program for installing the various programs on a computer can be stored in the storage medium. In addition, in the case where a program to be installed is compressed, a program for decompressing the compressed program can be stored in the storage medium.

In addition, the functions according to the above-described exemplary embodiments illustrated in FIG. 9 through FIG. 16 can be implemented by a host computer using a program that is externally installed. In this case, the present invention is applied to the case where a group of information including a program is supplied to an output device from a storage medium, such as a compact disc-read only memory (CD-ROM), a flash memory, and a floppy disk (FD) or from an external storage medium via a network.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

Accordingly, the program can be configured in any form, such as object code, a program executed by an interpreter, and script data supplied to an OS.

As the storage medium for supplying such program code, a flexible disk, a hard disk, an optical disk, a magneto-optical disk (MO), a CD-ROM, a compact disc recordable (CD-R), a compact disc rewritable (CD-RW), a magnetic tape, a nonvolatile memory card, a read-only memory (ROM), and a digital versatile disc (DVD), for example, can be used.

The above program can also be supplied by connecting to a web site on the Internet by using a browser of a client computer and by downloading the program from the web site to a storage medium, such as a hard disk. In addition, the above program can also be supplied by downloading a compressed file that includes an automatic installation function from the web site to a storage medium, such as a hard disk. The functions of the above embodiments can also be implemented by dividing the program code into a plurality of files and downloading each divided file from different web sites. That is, a World Wide Web (WWW) server and a file transfer protocol (ftp) server for allowing a plurality of users to download the program file for implementing the functional processing configure the present invention.

In addition, the above program can also be supplied by distributing a storage medium, such as a CD-ROM and the like, which stores the program according to the present invention after an encryption thereof, by allowing the user who is qualified for a prescribed condition to download key information for decoding the encryption from the web site via the Internet, and by executing and installing on the computer the encrypted program code by using the key information.

In addition, the functions according to the embodiments described above can be implemented not only by executing the program code read by the computer, but also implemented by the processing in which an operating system (OS) or the like carries out a part of or the whole of the actual processing based on an instruction given by the program code.

Further, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-206604 filed Aug. 8, 2007, which is hereby incorporated by reference herein in its entirety.

What is claimed is:

1. An information processing apparatus capable of using a management code including a plurality of layers to designate a charging destination in performing charging based on a result of processing performed by an image processing apparatus, the information processing apparatus comprising:
a designation unit configured to designate, for a print job, the management code in which a code has been designated for at least two layers, in response to a user instruction;
a determination unit configured to determine whether a conflict exists in print setting items corresponding to respective layers included in the management code designated by the designation unit; and
a setting unit configured to,
if it is determined by the determination unit that no conflict exists in the print setting items corresponding to respective layers, set, for the print job, a print setting based on the management code designated by the designation unit and,
if it is determined by the determination unit that a conflict exists in the print setting items corresponding to respective layers and a print setting is set, for the print job, based on the management code designated by the designation unit, set the print setting in the conflicting print setting items based on a policy for determining a print setting for the conflicting print setting items.

2. The information processing apparatus according to claim 1, wherein the policy prioritizes a print setting corresponding to a code designated for a higher-order layer included in the management code, in determining a print setting for the print setting items corresponding to the plurality of layers included in the management code when a conflict exists in the print setting items.

3. The information processing apparatus according to claim 1, wherein the policy prioritizes a print setting corresponding to a code designated for a lower-order layer included in the management code in determining a print setting for the print setting items corresponding to the plurality of layers included in the management code when a conflict exists in the print setting items.

4. The information processing apparatus according to claim 1, wherein the policy allows a user to manually select whether to prioritize a print setting corresponding to a code designated for a higher-order layer or a lower-order layer included in the management code, in determining a print setting for the print setting items corresponding to the plurality of layers included in the management code when a conflict exists in the print setting items.

5. The information processing apparatus according to claim 1, further comprising a changing unit configured to change the print setting set for the print job based on the policy such that a number of prints in the print job does not exceed an upper limit managed for the management code.

6. The information processing apparatus according to claim 1, further comprising a notification unit configured to, if a print setting set by a user for the print job is changed based on the print setting set by the setting unit, notify the user of the change.

7. A method for controlling an information processing apparatus capable of using a management code including a plurality of layers to designate a charging destination in performing charging based on a result of processing performed by an image processing apparatus, the method comprising:
designating, for a print job, the management code in which a code has been designated for at least two layers, in response to a user instruction;
determining whether a conflict exists in print setting items corresponding to respective layers included in the designated management code,
if it is determined that no conflict exists in the print setting items corresponding to respective layers, setting, for the print job, a print setting based on the designated management code; and
if it is determined that a conflict exists in the print setting items corresponding to respective layers, and a print setting is set, for the print job, based on the designated management code, set the print setting in the conflicting print setting items based on a policy for determining a print setting for the conflicting print setting items.

8. The method according to claim 7, wherein the policy prioritizes a print setting corresponding to a code designated for a higher-order layer included in the management code in determining a print setting for the print setting items corresponding to the plurality of layers included in the management code when a conflict exists in the print setting items.

9. The method according to claim 7, wherein the policy prioritizes a print setting corresponding to a code designated for a lower-order layer included in the management code in determining a print setting for the print setting items corresponding to the plurality of layers included in the management code when a conflict exists in the print setting items.

10. The method according to claim 7, wherein the policy allows a user to manually select whether to prioritize a print setting corresponding to a code designated for a higher-order layer or a lower-order layer included in the management code in determining a print setting for the print setting items corresponding to the plurality of layers included in the management code when a conflict exists in the print setting items.

11. The method according to claim 7, further comprising changing the print setting set for the print job based on the policy such that a number of prints in the print job does not exceed an upper limit managed for the management code.

12. The method according to claim 7, further comprising, if a print setting set by a user for the print job is changed based on the set print setting, notifying the user of the change.

13. A computer-readable storage medium storing a program for causing a computer to perform the method according to claim 7.

14. An information processing system including a server apparatus configured to manage a management code including a plurality of layers for designating a charging destination in performing charging based on a result of processing performed by an image processing apparatus, and an information processing apparatus configured to be in communication with the server apparatus, the information processing system comprising:
a first registration unit configured to register print setting items corresponding to respective layers included in the management code and a print setting corresponding to a code set for each of the plurality of layers;
a second registration unit configured to, if a conflict exists in the print setting items corresponding to the respective layers included in the management code, register a policy for determining a print setting for the conflicting print setting items;
a designation unit configured to designate the management code for the print job based on a user instruction on the information processing apparatus;
a determination unit configured to determine whether a conflict exists in print setting items corresponding to the respective layers included in the management code designated by the designation unit;
a setting unit configured to,
if it is determined by the determination unit that no conflict exists in the print setting items corresponding to respective layers, set, for the print job, a print setting based on the management code designated by the designation unit and,
if it is determined by the determination unit that a conflict exists in the print setting items corresponding to respective layers, and a print setting is set, for the print job, based on the designated management code, set the print setting in the conflicting print setting items based on the policy; and
a storage unit configured to acquire a print result of the print job managed by the image processing apparatus and to store the print result in association with the management code designated for the print job.

15. A method for controlling an information processing system including a server apparatus configured to manage a management code including a plurality of layers for designating a charging destination in performing charging based on a result of processing performed by an image processing apparatus, and an information processing apparatus configured to be in communication with the server apparatus, the method comprising:
registering print setting items corresponding to respective layers included in the management code and a print setting corresponding to a code set for each of the plurality of layers,
if a conflict exists in the print setting items corresponding to the respective layers included in the management code, registering a policy for determining a print setting for the conflicting print setting items;
designating the management code for the print job based on a user instruction on the information processing apparatus;
determining whether a conflict exists in print setting items corresponding to respective layers included in the designated management code,
if it is determined that no conflict exists in the print setting items corresponding to the respective layers, setting, for the print job, a print setting based on the designated management code;
if it is determined that a conflict exists in the print setting items corresponding to respective layers, and a print setting is set, for the print job, based on the designated management code, setting the print setting in the conflicting print setting items based on the policy; and
acquiring a print result of the print job managed by the image processing apparatus and storing the print result in association with the management code designated for the print job.
